(19) United States
(12) Patent Application Publication
(10) Pub. No.: US 2012/0179389 A1
(43) Pub. Date: Jul. 12, 2012

(54) Gas Chromatographic Analysis Method and System

(75) Inventors: Daniel Reisfeld, Tel Aviv (IL); Avi Rubinstein, Kfar Bilu (IL)

(73) Assignee: SPECTROSENSE LTD., Nes Zionna (IL)

(21) Appl. No.: 13/391,359

(22) PCT Filed: Aug. 18, 2010
(86) PCT No.: PCT/IL10/00675

§ 371 Date: Mar. 22, 2012

Related U.S. Application Data
(60) Provisional application No. 61/235,457, filed on Aug. 20, 2009.

(51) Int. Cl. G06F 19/00

(52) U.S. Cl. 702/24

(57) ABSTRACT

Method employing gas chromatography for determining a measure of match between chromatographic data respective of a sample and reference data, the method includes the procedures of acquiring the chromatographic data, determining a plurality of parameters in a modeling function so as to substantially fit the modeling function to the chromatographic data, the modeling function defined as a sum of a linear combination of probability distribution functions, and estimating the measure of match according to a degree of fitness between the modeling function and the chromatographic data.

### FIELD OF THE DISCLOSED TECHNIQUE

The disclosed technique relates to gas chromatography in general, and methods and systems for analyzing gas chromatographic data, in particular.

### BACKGROUND OF THE DISCLOSED TECHNIQUE

Gas liquid partition chromatography (GLPC), vapor-phase chromatography (VPC), gas-liquid chromatography, also known more simply as gas chromatography (GC), are names of analytical chemistry techniques employed for separating and analyzing chemical mixtures or compounds that can be vaporized without chemical decomposition. GC is utilized for separating a sample, such as a gaseous mixture into its chemical constituents, where the relative quantities of the constituents may be determined. GC may also be employed for testing the purity of a substance, for assisting in the identification of compounds, and for the preparation of pure compounds from a mixture. GC is performed by an instrument, generally termed a gas chromatograph or gas separator. Generally, the GC technique involves introducing a sample, in vaporized form (e.g., via direct injection, purge-and-trap (P/T) techniques), into one end of a GC column (hereinafter “column”), internally constructed to have an inert solid support coated with different solid or liquid stationary phases (i.e., absorbents). A mobile phase (i.e., a carrier gas, such as helium) is employed to sweep the sample through the column. Disparate constituents of the sample interact differently with the stationary phase, as the sample is swept through the column, causing each constituent to elute at a different time (i.e., known as the retention time of the constituent). The rates at which the different chemical constituents of the sample pass through the column depend on their chemical and physical properties as well as their interaction with the stationary phase. As the constituents emerge from the other end of the column at different times, depending on each of their respective retention times, they may be detected by detectors employing various detection techniques. The detector typically produces an electrical signal in response to the concentration of the constituents in the sample. The chromatographic data is typically presented in the form of a graph (e.g., a spectrum) of the detector response (concentration) as a function of the time (retention time), referred to as a chromatogram. Consequently, for each sample, the GC produces a corresponding chromatogram having a spectrum of peaks, which represent the analytes present in the sample eluting from the column at different times. By quantitatively analyzing the spectral patterns present in the chromatogram of the sample, by comparing them to a certain standard containing known concentrations of analytes, it is possible to determine the concentration of the analyte in the sample.

Consequently, GC is employed in a wide diversity of fields, such as in biomedical applications, environmental applications, in forensic analysis, petrochemical analysis, etc. For example, GC is employed in the analysis of exhaled human and animal breath for volatile organic compounds (VOCs). VOCs, in general, are gases or vapors that are emitted by various materials (e.g., cleaning supplies, paint, pesticides, building materials) that may pose adverse health effects to living beings. Humans are naturally exposed to VOCs through inhalation, ingestion, skin absorption, and the like. By examining exhaled human breath, which naturally contains hundreds of VOCs, it is possible provide an indication to potentially deleterious build-up of chemicals in the body. Detected VOC's in exhaled human breath may thus serve as biological markers (i.e., biomarkers) in testing for the likelihood of the presence of diseases such as lung cancer, breast cancer, diabetes, and schizophrenia.

It is known, however, that the analysis of chromatographic data, particularly the complete separation and resolution of a sample into its constituents may be difficult due to the occurring phenomenon of overlapping peaks that are present in chromatograms. Basically, this problem arises when two or more different constituents of a sample elute at substantially the same rate (i.e., they substantially have similar retention times) and are detected as though they were a single component.

Various types of apparatuses and chromatographic separation methods are known in the art. One such method for enhancing the detection of overlapping chromatographic peaks involves the use of multi-dimensional gas chromatography (herein abbreviated MDGC), where components of the sample are subject to two or more separation steps using two or more columns that possess different characteristics. In two-dimensional (2-D) gas chromatography (herein abbreviated 2D-GC), for example, regions in the chromatogram which require additional analysis are enriched (“heart-cut”) and assayed on a second column. Another method involves the use of comprehensive 2D-GC (herein abbreviated GC×GC), which is based on the collection of effluent from a first column and periodic re-injection of portions of the effluent into a second column having different properties. In this method, effluent from the first column is sampled multiple times such that the entire sample is subjected to all of the separation steps (i.e., dimensions), while preserving the separation from each previous step. This method relies on an interface that connects the first and second columns, which enables periodic injection to occur. Nonetheless, the use of these techniques entails additional equipment as well as the analysis of multiple channels of spectral data, which ultimately do not guarantee complete identification of all components that comprise a particular sample.

Methods and systems for analysis of gas chromatographic data are also known in the art. For example, it is known in the art to employ exponentially modified Gaussian (EMG) functions in characterizing the shape of chromatographic peaks, the theoretical justifications of which lie in the fact that chromatographic peaks usually exhibit asymmetrical properties. Other methods include deconvolution techniques, iterative target transform factor analysis (ITTFA), pattern recognition and neural network techniques, and the like. U.S. Pat. No. 7,403,859 B2 to Ito et al., entitled “Method and Apparatus for Chromatographic Data Processing” is directed to a liquid chromatographic analyzer for facilitating curve fitting by employing a linear least-square method for a chromatogram that contains a plurality of overlapping peaks. The liquid chromatic analyzer includes a column, a sample supply portion, a fluid pump, a controller, a sampler, and a detector. The sample supply portion is arranged between the fluid pump and the column. An eluting solution is pumped to the column using the fluid pump by instruction from the controller. A sample is supplied from the sampler to the eluting solution by instruction of the controller. The sample is separated by the column and detected by the detector. A chromatogram of the detected data is transmitted to the controller to be analyzed.

Data processing of the chromatogram by the controller is executed by a procedure that includes specification of a time interval to execute fitting, selecting a waveform function, selection of a weighting pattern, selection of a fitting direction, clicking of the fitting execution button, and displaying and outputting of the result. Initially, for a particular selected chromatogram, a time interval in the chromatogram is selected for fitting by inputting a starting time and an ending time. Subsequently, a Gaussian or EMG function is used as the waveform function for fitting. The selection of the weighing function involves superimposing a graphical representation of the weighing function onto the chromatogram via a pointing device. The selection of the fitting direction involves setting of the direction whether the processing is to be executed from the front side or the back side of the selected time interval in the chromatogram. The fitting processing (execution) utilizes a waveform function for fitting, which is a sum of Gaussian functions and a base line (i.e., a linear line equation). The fitting processing employs a least-square method such that the fitting parameters in the Gaussian functions are determined so as to minimize the sum of the square of the differences between the waveform function and the respective points in the signal intensity of the measured chromatogram.

### SUMMARY OF THE DISCLOSED TECHNIQUE

It is an object of the disclosed technique to provide a novel system and method employing gas chromatography, which overcomes the disadvantages of the prior art. In accordance with the disclosed technique, there is thus provided a method for determining a measure of match between gas chromatographic data respective of a sample and reference data. The method includes the procedures of acquiring the gas chromatographic data, determining a plurality of parameters in a modeling function so as to substantially fit the modeling function to the gas chromatographic data, and estimating the measure of match according to a degree of fitness between the modeling function and the gas chromatographic data. The modeling function is defined as a sum of a linear combination of probability distribution functions.

According to another aspect of the disclosed technique, there is thus provided a system for analysis of gas chromatographic data. The system includes a chromatographic separation column for separating a sample into a plurality of constituents, a sample delivery device, a detector, a memory device, and a processor. The chromatographic separation column includes an inlet and outlet. The sample delivery device is coupled with the chromatographic separation column at the inlet thereof, in order to provide the sample to the chromatographic separation column. The detector, which is in communication with the outlet of the chromatographic separation column, detects at least a portion of the plurality of constituents and produces a signal that includes the gas chromatographic data respective of the characteristics of the detected portion of the sample. The memory device, which is coupled with the processor, stores the gas chromatographic data and a plurality of reference data. The processor, which is coupled with the detector, determines a plurality of parameters in a modeling function so as to substantially fit the modeling function to the gas chromatographic data. The modeling function is defined as a sum of a linear combination of probability distribution functions. The processor estimates a measure of match between the gas chromatographic data and the plurality of reference data according to a degree of fitness between the modeling function and the gas chromatographic data.

### BRIEF DESCRIPTION OF THE DRAWINGS

The disclosed technique will be understood and appreciated more fully from the following detailed description taken in conjunction with the drawings in which:

FIG. 1 is a schematic illustration of a system for analysis of gas chromatographic data, constructed and operative according to an embodiment of the disclosed technique;

FIG. 2A is a schematic illustration of a representative chromatogram, acquired by the system illustrated in FIG. 1;

FIG. 2B is a schematic illustration of a graph of an initial estimate of a time-dependent modeling function, modeled according to the chromatogram of FIG. 2A;

FIG. 2C is a schematic illustration of a graph of the calculated time-dependent model error resulting from the initially estimated modeling function of FIG. 2B, plotted in conjunction with a graph of a time-dependent model error threshold function;

FIG. 2D is a schematic illustration of a refined estimate of the time-dependent modeling function of FIG. 2B, modeled according to the chromatogram of FIG. 2A;

FIG. 3A is a schematic block diagram illustrating the method for resolving and identifying components within overlapping chromatographic peaks whose different constituents compose a given sample, constructed and operative according to another embodiment of the disclosed technique; and

FIG. 3B is a schematic block diagram illustrating a continuation of the method of FIG. 3A.

### DETAILED DESCRIPTION OF THE EMBODIMENTS

The disclosed technique overcomes the disadvantages of the prior art by providing a method and system for resolving and identifying components within overlapping chromatographic peaks whose different constituents compose a given sample, by employing a modeling function defined as a sum of a linear combination of probability density functions. Chromatographic data associated with the chemical constituents that compose the given sample is acquired by one-dimensional GC (herein abbreviated 1 D-GC) gas chromatographic separation techniques (i.e., in contrast to multi-dimensional gas chromatographic techniques, such as MDGC and 2D-GC). Significant features (e.g., chromatographic peaks) within a chromatogram of the sample are mathematically decomposed, in such a way that they may be classified, and thereafter represented (i.e., modeled) by a particular type of probability density function according to the implemented classification. A plurality of parameters characterizing each of the probability density functions are estimated by optimization techniques and thereafter, a plurality of linear coefficient parameters in the sum of the linear combination of probability density functions are determined by a least squares approach. A time-dependent model error function and a model error threshold parameter are defined. Chromatographic peaks suspected of being composite are substantially determined (i.e., assessed, estimated) by initially evaluating the time values for which the time-dependent model error threshold parameters exceed the time-dependent model error. A refined modeling function is constructed by remodeling the peaks suspected of being composite by a plurality of probability density functions, taking into account the corresponding model error of each respective peak, thereby resolving composite chromatographic peaks. The optimization techniques are repeated in order to substantially fit the modeling function to the chromatographic data, so as to minimize the least square error. At each iteration, the refined modeling function substitutes the previous modeling function until the model error is minimized. The disclosed technique estimates a measure of match between reference peaks, the information of which is stored in a database, and the plurality of peaks including the newly discovered and resolved peaks of the sample, in order to deduce the presence or absence of particular biomarkers of interest in the analyzed sample. Generally, the disclosed technique may typically be implemented for providing a probabilistically determined indication of the presence of multi-biomarkers in a breath sample, collected from individual suspected of having a particular adverse medical condition (e.g., cancer).

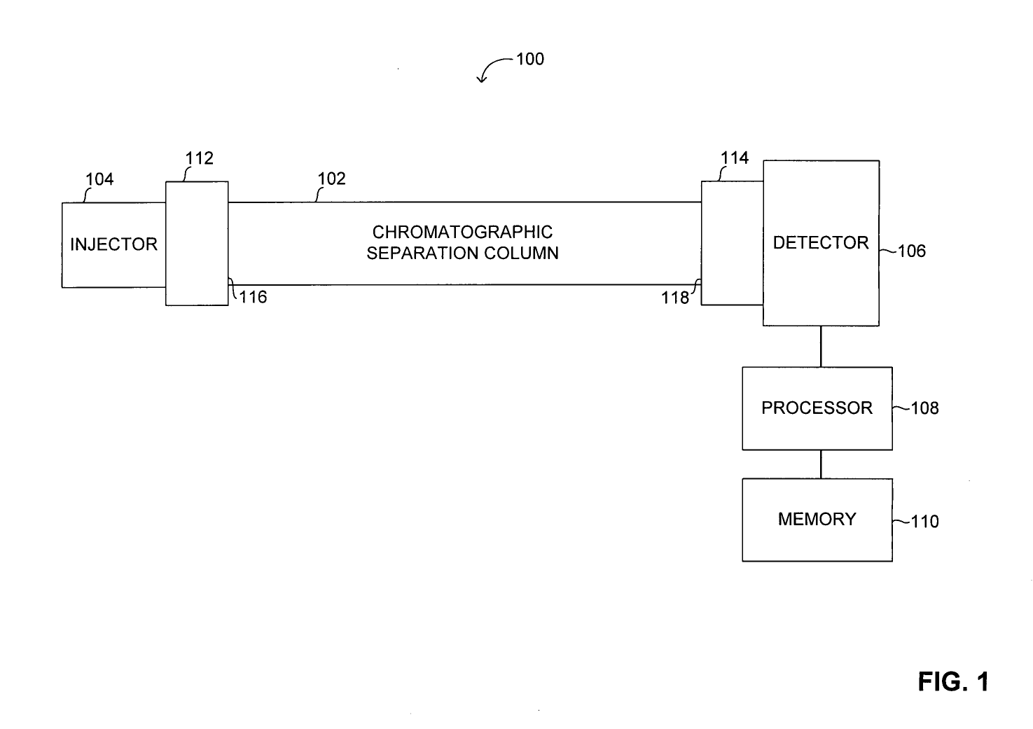

The terms “probability density function” and “probability distribution function” used throughout the detailed description, the Figures, and the claims are interchangeable. Reference is now made to FIG. 1, which is a schematic illustration of a system for analysis of gas chromatographic data, generally referenced 100, constructed and operative according to an embodiment of the disclosed technique. System 100 includes a chromatographic separation column 102, a sample delivery device 104, a detector 106, a processor 108, and a memory device 110. System 100 may optionally further include an inlet chamber 112 and an outlet chamber 114. Chromatographic separation column 102 includes an inlet 116 and an outlet 118. Sample delivery device 104 is coupled with chromatographic separation column 102 via inlet 112. Alternatively, sample delivery device 104 may be coupled with chromatographic separation column 102 via inlet chamber 112 (as shown in FIG. 1). Detector 106 is coupled with chromatographic separation column 102 at outlet 114. Alternatively, detector 106 is coupled with chromatographic separation column 102 via outlet chamber 114 (as shown in FIG. 1). Detector 106 is coupled with processor 108, which in turn is coupled with memory device 110.

Initially, a sample (not shown) to be analyzed (e.g., a breath sample) is provided into sample delivery device 104. Alternatively, the sample may initially be collected (i.e., via a sample collection device) in a sealed sorbent tube (not shown) such as a probe sampling device (PSD) and dispensed thereafter to sample delivery device 104. In the case where inlet chamber 112 is not employed, sample delivery device 104 introduces the sample, into a continuous flow of a carrier gas (not shown), such as helium, nitrogen, argon, and dried air, which sweeps the sample to inlet 116 of chromatographic separation column 102 (referred as an “on-column inlet”). Introduction of the sample to inlet 116 may be achieved automatically, such as through the use of auto-samplers and auto-injectors, which are known in the art. In the case where inlet chamber 112 is employed, it generally functions as an evaporation chamber (i.e., which is temperature-controlled) for facilitating the volatilization of the sample, typically in use with S/SL (Split/Splitless) injectors (i.e., a type of sample delivery device). Other types of sample delivery devices and techniques may be employed, for example, P/T (Purge-and-Trap) systems, gas source switching systems, SPME (Solid Phase Micro-Extraction), PTV (Programmable Temperature Vaporizing) injection, micro-syringe direct injection, thermal desorbers, and the like. For part of such implementations, system 100 may further include a carrier gas tank (not shown), for supplying the carrier gas, where other various interrelated equipment (not shown) for this purpose, such as flow controllers, valves, pressure sensors, and the like, may also be utilized.

As the sample passes through chromatographic separation column 102, various constituents (not shown) of the sample are separated by adsorption, and elute at different rates as they emerge from outlet 118 into outlet chamber 114. Outlet chamber 114 may include, for example, an eluent-jet interface, a nebulization liquid introduction system, and the like. In the nebulization liquid introduction system, an eluent-gas mixture is nebulized (i.e., as an aerosol) and sprayed directly into detector 106 or alternatively, into part of outlet chamber 114, thus creating an aerosol having improved uniformity. By employing eluent-jet or nebulization liquid introduction systems, for example, packed capillary columns, may be interfaced directly to detectors which are based on flame ionization, flameless thermionic ionization, photometric type detectors, and the like. Chromatographic separation column 102 is preferably a capillary type column, generally affording a relatively higher sensitivity than those of packed column types (i.e., since overall, the detected chromatographic peaks are higher and much sharper, thereby yielding better signal-to-noise ratio). The disclosed technique, however, is not limited to a particular type of chromatographic column, as other types of columns may be utilized (e.g., packed columns, internally heated microFAST columns, micro-packed columns). Since molecular adsorption and the rate at which the sample progresses through chromatographic separation column 102 are temperature-dependent, it is usually necessary to control the temperature of chromatographic separation column 102. For such a purpose, an oven (not shown) is usually employed to house and maintain chromatographic separation column 102 at a desired temperature. The temperature of the oven is electronically controlled to typically hold chromatographic separation column 102 at particular isothermal conditions for each analysis that is performed.

When the eluates (i.e., effluents) emerge from chromatographic separation column 102, at least a fraction of the constituents that composed the sample are detected by detector 106 (arranged to be in communication with outlet 118). Many types of detectors may be used in GC. GC detectors may be classified according to their selectivity (i.e., a measure of the ability of a detector to respond, in relative terms, to a particular element or compound versus other elements or compounds), and other factors, such as whether they are concentration dependant detectors or mass flow detectors, etc. Selective detectors, for example, respond to a diversity of compounds having a mutual chemical or physical property, whereas non-selective (universal) detectors respond to substantially all compounds apart from the carrier gas. The various types of detectors that may be employed by the disclosed technique, include flame ionization detectors (FID), thermal conductivity detectors (TCD), electron capture detectors (ECD), nitrogen phosphorus detectors, flame photometric detectors (FPD), photo-ionization detectors (PID), Hall electrolytic conductivity detectors, discharge ionization detectors (DID), pulsed discharge ionization detectors (PDD), mass selective detectors (MSD), helium ionization detectors (HID), thermal energy (conductivity) analyzer/detectors (TEA/TCD), and the like. The TCD is an example of a concentration dependant detector having universal selectivity. The FPD is an example of a selective detector of mass flow type, whose selectivity is toward phosphorous, tin, germanium, sulfur, selenium, etc. Detector 106 typically produces an electrical signal, s(t) in response to the detected concentration of the constituents in the sample as a function of time. This electrical signal is transferred to processor 108 for processing and analysis. Alternatively, system 100 may further include an amplification stage (not shown), operational between detector 106 and processor 108, for amplifying the electrical signal produced by detector 106. The amplification stage may be implemented by preamplifiers, amplifiers, electrometric amplifiers (EMA), and the like.

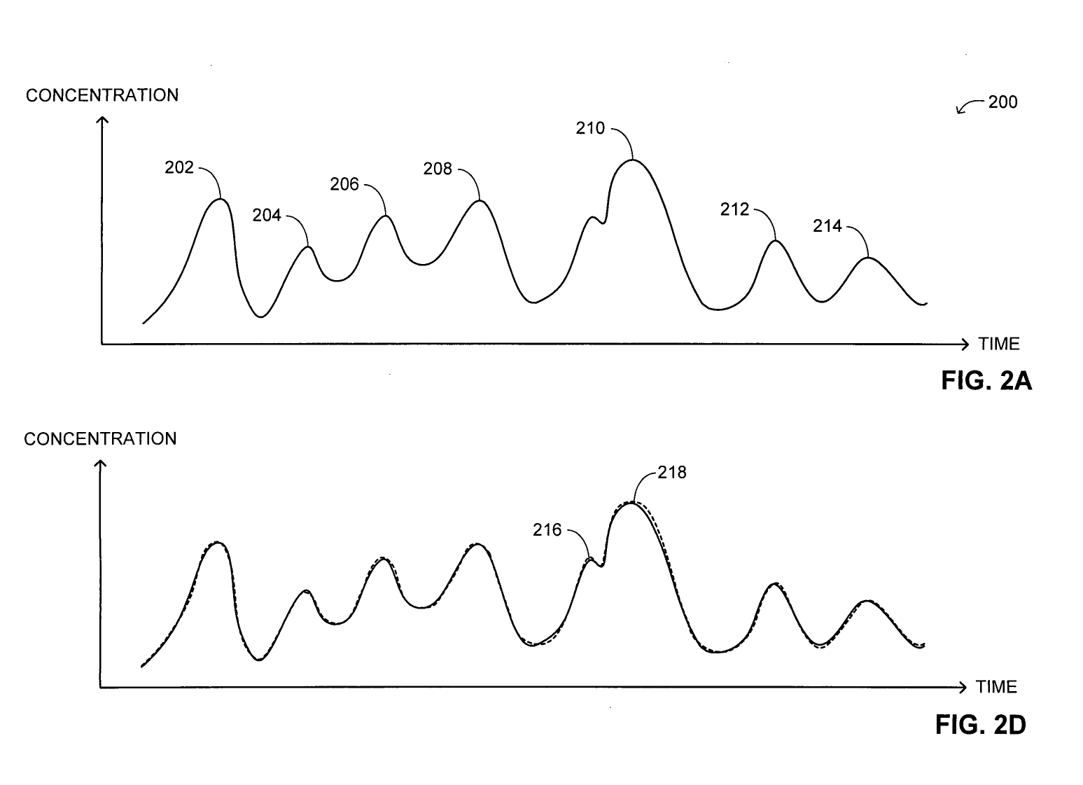

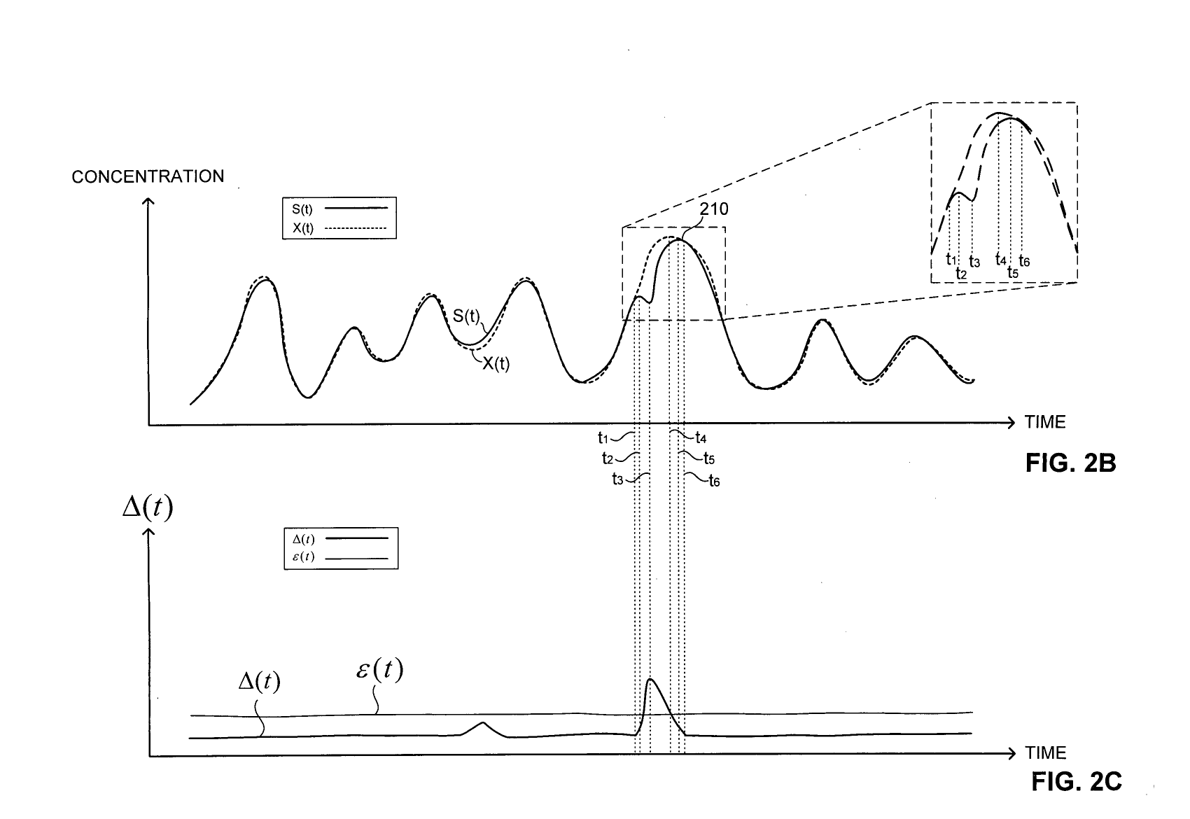

The electrical signal is a representation of chromatographic data (not shown), which processor 108 transfers to memory device 110 for storage and retrieval. The chromatographic data respective of each electrical signal that is analyzed by processor 108 may be arranged and presented in the form of a chromatogram. Reference is now further made to FIGS. 2A and 2B. FIG. 2A is a schematic illustration of a representative chromatogram, generally referenced 200, acquired by the system illustrated in FIG. 1. FIG. 2B is a schematic illustration of a graph of an initial estimate of a time-dependent modeling function, modeled according to the chromatogram of FIG. 2A. Chromatogram 200 represents a graphical record of the chromatographic separation of a particular sample, presented in a Cartesian coordinate system, the vertical axis of which represents a measure of concentration of detected eluted materials (i.e., the detector response), as a function of time (horizontal axis). Chromatogram 200 includes a plurality of chromatographic peaks 202, 204, 206, 208, 210, 212 and 214 each of which represents a particular component or a combination of different merged components (i.e., not separated by GC). Detected electrical signal s(t) can be normalized in order to account (e.g., compensate) for the presence of disproportionate concentrations of constituents composing a given sample, which for example, may be due to external influences such as from other chemicals or from the specific pre-selectivity of the detector that is employed.

Memory device 110 stores a database (not shown) of a plurality of reference GC data corresponding to known chemical compositions. Particularly, the database stores data corresponding to a set D′ of peaks, where each element in this set represents a chromatographic peak of a known chemical composition, associated with a particular adverse medical condition (e.g., disease, infection). Data corresponding to single or combination of chemical compositions, within the database, may be grouped to define a biomarker (not shown). For example the subset {d_{8′}, d_{34′}, d_{371′}}⊂D′ may define a biomarker of a particular disease. A biomarker generally refers to a component (or a plurality of components) whose qualitative and quantitative presence or absence in chromatographic data of a sample is an indicator of a particular biological state of a biological being (e.g., human, dog, cat). The database further stores a set M′ of biomarkers, where each biomarker element is defined as a subset of D′. The primed indices herein denote reference data. In view of the aforementioned example, a biomarker m_{1′}⊂M′ may be defined as m_{1′}={d_{8′}, d_{34′}, d_{371′}}. Likewise, the database stores data corresponding to a set H′ of peaks, where each element in this set represents a chromatographic peak of a chemical composition that is either unknown to be associated with a particular adverse medical condition (e.g., typically appearing in healthy individuals), or that it is known to be associated with a particular adverse medical condition, but nonetheless, is not of interest for detection.

The database is initially constructed at a learning and calibration stage. In this stage, chromatographic data (i.e., chromatograms) from a plurality of known and possibly unknown chemical compositions is acquired, wherefrom it will ultimately constitute as reference chromatographic data. In particular, chromatographic data (e.g., peaks) from a plurality of VOCs is acquired (e.g., via a breath sample) from individuals diagnosed with a particular medical condition of interest (i.e., in detection) and compared with a plurality of VOCs acquired from individuals diagnosed as not having that particular medical condition of interest in order to identify chromatographic data that characterizes the medical condition of interest (i.e., biomarkers). Mass spectrometry (MS) as well as spectroscopy techniques may be employed in this stage as a method of calibration, where the elemental composition of each sample that is collected is compared and associated with the respective retention time of each component in the sample. Generally, chromatographic data of VOCs from both “healthy” and “unhealthy” individuals are collected, analyzed, and stored in the database. Analysis of the chromatographic reference data may be performed by the detection of chromatographic peaks by, for example, principal component analysis (PCA), and the like. Each detected chromatographic peak may be modeled by a particular probability density function, according to the methods which will be described in greater detail herein below.

The disclosed technique resolves and identifies components within overlapping chromatographic peaks whose different constituents compose a given sample, by employing a modeling function defined as a linear combination of probability density functions (also referred to as probability distribution functions), Vᵢ having the general form:

$${\sum }_{i} {α}_{i} {V}_{i} \qquad ( 1 )$$

where αᵢ the coefficients of the probability density functions, and i is a positive integer. In particular, it is assumed, according to the disclosed technique that the linear combination of probability density functions in expression (1) may be decomposed into a linear combination of probability density functions, having the form:

$$x ( t ) = {\sum }_{j} {β}_{j} {D}_{j} ( t ) + {\sum }_{k} {η}_{k} {H}_{k} ( t ) + {\sum }_{l} {δ}_{l} {O}_{l} ( t ) + {\sum }_{m} {ι}_{m} {I}_{m} ( t ) \qquad ( 2 )$$

where x(t) represents the time-dependent modeling function utilized to model the electrical signal s(t), acquired by detector 106. It is noted that electrical signal s(t) might have undergone modification (e.g., amplification, preprocessing). Dⱼ(t) represents the jth time-dependent probability density function that models a respective chromatographic peak (i.e., that is substantially unresolved) having a likelihood of corresponding to a particular chromatographic peak in set D′ (i.e., associated with a particular adverse medical condition). Each of the k time-dependent probability density functions Hₖ(t) model a chromatographic peak (i.e., that is in general, partially resolved) having a likelihood of corresponding to a particular chromatographic peak in set H′ (i.e., that is either unknown to be associated with a particular medical condition, or that is known to be associated with a particular medical condition, but nonetheless is not of interest for detection). Isolated chromatographic peaks (i.e., those which are generally resolved), whether they are known or unknown to be associated with a particular medical condition are modeled by mth time-dependent probability density function Iₘ(t) (i.e., have a likelihood of corresponding to a particular chromatographic peak either in set H′ or D′). Oₗ(t) represents the lth time-dependent probability density function that respectively models unknown chromatographic peaks (i.e., unclassifiable chromatographic data that is not part of the database) or remainder terms resulting from the modeling procedure. The scalar weights βⱼ, ηₖ, δₗ and tₘ are coefficients in the linear combinations with each of the respective probability density functions Dⱼ(t), Hₖ(t), Oₗ(t), and Iₘ(t). Indices j, k, l, and m are positive integers.

A variety of probability density functions may be used for Dⱼ(t), Hₖ(t), Oₗ(t), and Iₘ(t), such as EMGs, gamma distribution (i.e., the probability density function thereof), polynomial modified Gaussians, Skew-normal distribution, Chi distribution, Poisson distribution, Maxwell-Boltzmann distribution of normalized molecular speeds (i.e., the Chi distribution with three degrees of freedom (DOF)), Maxwell-Bolzmann distribution modified for retention times, Rayleigh distribution (i.e., the Chi distribution with two DOF and a standard deviation, a σ=1), and the like.

The modeling process may initially model isolated chromatographic peaks (i.e., peaks 202 and 212), which appear in chromatogram 200. For these peaks and generally, for each peak in that is suspected to be an isolated peak, processor 108 finds a respective time-dependent probability density function Iₘ(t), which will serve as a mathematical model for that peak. A particular parametric family of time-dependent probability density functions that may be used is the gamma probability density function, parameterized in terms of a shape parameter ζ≧0, (κ ∈ [symbol] ) and a scale parameter θ≧0 (θ ∈ [symbol] ), having the general form:

$$ι ( t ; ζ , θ ) = {t}^{κ - 1} \frac{{e}^{- t / θ}}{{θ}^{κ} Γ ( ζ )} \qquad ( 3 )$$

where t≧0, and Γ(κ) is the gamma function, given by:

$$Γ ( ζ ) = {\int }_{0}^{∞} {y}^{ζ - 1} {e}^{- y} d y . \qquad ( 4 )$$

Concurrently, the modeling process employs the gamma probability density function to model other peaks, which appear in chromatogram 200 (i.e., peaks 204, 206, 210, 212 and 214). By comparing the mode position of each peak (e.g., maximum peak height thereof) along the time axis with data corresponding to the positions of reference chromatographic peaks in sets D′ and H′, stored in memory device 110, processor 106 estimates the likelihood of match between each of the peaks in chromatogram 200 and the respective reference chromatographic peaks. Peaks in chromatogram 200, which substantially match reference chromatographic peaks, in this manner, are classified according to their type. Consequently, each chromatographic peak is classified as being either an isolated peak, an unknown peak, or one which substantially matches corresponding reference chromatographic peaks in either sets D′, H′, stored in the database. For example, processor 106 estimates that peaks 204 and 208 substantially match respective reference chromatographic peaks d₁ and d₂ in set D′, that peak 206 substantially matches reference chromatographic peak h₁ set H′, and that peaks 210 and 214 are to be classified as unknown. At least in a preliminary phase in the modeling process, those chromatographic peaks, which are classified as unknown, do not substantially correspond to reference chromatographic peaks in sets D′ and H′. Once a previously unidentifiable chromatographic peak is identified, it may be reclassified accordingly. For the purpose of elucidating the disclosed technique, it is supposed that peak 210 is composite (i.e., consisting of at least two components, which overlap to a certain degree). Processor 106, without a priori knowledge, initially classifies peak 210 as an unknown peak, which is to be modeled, accordingly, by the probability density functions Oₗ(t). It is noted that a chromatographic peak classified as an isolated peak, may also correspond to a reference chromatographic peak in sets D′ or H′. In this case, these isolated peaks are modeled according to the time-dependent probability density function Iₘ(t) for isolated peaks, mentioned above. For example, peak 212 is classified and modeled as an isolated peak, although this peak is attributable to a reference chromatographic peak in set H′. Thus, each of the classified chromatographic peaks is modeled according to its respective probability density function (i.e., Dⱼ(t), Hₖ(t), Oₗ(t), and Iₘ(t)).

Processor 106 may employ registration procedures to facilitate classification of the chromatographic peaks according to chromatographic peak type (e.g., according to temporal attributes of each chromatographic peak). Particularly, processor 106 registers chromatographic peaks in the chromatographic data of detected electrical signal, s(t) with the reference chromatographic peaks that are stored in the database, by comparing the retention time values of the chromatographic peaks with corresponding reference retention time values of the reference chromatographic peaks. Processor 106 may compare the mode (or mean) position in the time domain (i.e., along the time axis) of each chromatographic peak with data corresponding to the positions of reference chromatographic peaks stored in memory device 110. Registration involves employment of a monotonic transformation function f(t) such that s(f (t)) is matched to a database entry r(t). Preferably, the transformation function is linear (i.e., f(t)=a·t+b, where a and b are parameters), however, the transformation function may also be non-linear. The transformation function is chosen so that a matching score (i.e., yielded from matching s(f(t)) with corresponding r(t)'s) is maximal within predefined ranges for a and b. This may be achieved by employing exhaustive search techniques, or preferably by using an optimization procedure such as the Gauss-Newton method. Alternatively, the transformation function is chosen in the manner that takes into account chromatographic peaks that recurrently appear (e.g., that of 2-methyl-undecane). Further alternatively, registration involves insertion (via inlet 112) of specific chemicals (i.e., by adding, mixing with the sample to be analyzed) whose retention times are known so as to produce known chromatographic peaks having respectively known retention times. The transformation function is constructed so as to account for these known chromatographic peaks in order to facilitate registration.

Chromatographic peaks registered in the time domain with corresponding reference chromatographic peaks are classified according to their type (e.g., isolated chromatographic peaks, those substantially matching reference chromatographic peaks, unknown chromatographic peaks). The gamma probability density function that models each of the classified chromatographic peaks is characterized by the location of the peak with respect to the time axis (e.g., the mean, μ=ζθ), ζ, and θ. Processor 106 initially guesstimates these parameters for each probability density function that is used to model a chromatographic peak. For example, chromatographic peaks classified as those substantially corresponding to reference chromatographic peaks in set D′, are modeled by probability density functions Dⱼ(t;ζⱼ, θⱼ). To optimize the initial guesstimate, processor 106 employs optimization techniques, such as the method of steepest descent (i.e., gradient descent) to search for improved solutions of the parameters in each of the probability density functions (i.e., the evaluation functions) that model chromatographic peaks in chromatogram 200. Utilizing the weighted average around the peak location substantially ensures that the probability density functions are sufficiently smooth at the initial guesstimate solution, at least in a neighborhood thereof, as well as the existence of the directional derivative for probability density functions. By defining for each probability density function a parameter vector p as a column vector of a preset number of real-valued parameters p=(μ,ζ,θ), a new solution is generated according to the following iterative rule:

pᵣ₊₁=pᵣ−sᵣ∇pdf(pᵣ) (5)

where “pdf” denotes the probability density function, r≧1, ∇pdf(pᵣ) is the gradient of a particular density function at pᵣ, and s₁ is a chosen step size parameter. According to this method, the parameter vector p is adjusted (i.e., perturbed) by small amounts in the direction that would most likely reduce evaluations of candidate solutions to the moment parameters in each of the probability density functions. Generally, since each iteration reduces the model error, iterative solutions generated by gradient descent method converge to substantially optimal values p₀=(μ₀,ζ₀,θ₀). It is noted that in cases where solutions generated by the gradient descent method become caught in local minima, the disclosed technique may employ simulated annealing techniques, and the like. Alternatively, parameter vector p may be defined as a column vector of the first four moments of the gamma distribution function (i.e., or other distribution function for that matter) such that p=(μ, var, γ,κ), where the mean, variance, skewness, and kurtosis (specifically, the excess kurtosis) are given respectively by μ=ζθ, var=ζθ², γ=2/\sqrt{ζ}, and κ=6/ζ. Typically, one of the moments (e.g., the kurtosis) is fixed to an initial guesstimate value, while the gradient descent optimization procedure proceeds in finding candidate solutions for the other moments in the evaluation function. A qualitative measure of the goodness of a result p₀=(μ₀, var₀, γ₀), obtained from the gradient descent optimization procedure, may be substantially verified by comparing the calculated value for the kurtosis with the value of the kurtosis extrapolated from the values obtained from the optimization procedure. Alternatively, the disclosed technique may employ other optimization methods, such as the method of Newton, Quasi-Newton methods, the Gauss-Newton method, the Levenberg-Marquardt algorithm (LMA), and the like. For example, in the method of Newton, the convergence toward a local minimum is considerably faster than that of gradient descent, however, it is required to calculate the inverse of the Hessian matrix of the probability distribution functions, which may occasionally be problematical (e.g., ill-defined).

The candidate parameters to the probability density functions, yielded from the gradient descent optimization procedure are employed to characterize the modeling function. A least square method is employed to fit the modeling function to the experimental data, that of electrical signal s(t). In particular, a sum S of the square of the differences between the time-dependent modeling function and an arbitrary integer number (e.g., n >0) of respective points in detected electrical signal s(t) is to be minimized:

$$S = {\sum }_{i = 1}^{n} {( {S}_{i} ( t ) - {x}_{i} ( t ) )}^{2} \qquad ( 6 )$$

Processor 106 determines by the least square method the linear coefficient parameters (i.e., the scalar weights) βⱼ, ηₖ, δₗ and tₘ from n equations, as there may be more equations than unknowns. A first estimate of the modeling function is defined once the linear coefficient parameters are substantially known. A graph of an initial estimate of the time-dependent modeling function x(t) is illustrated in FIG. 2B. To obtain a possibly improved estimate of the modeling function, the gradient descent method is applied once more, in accordance with equation (5), to optimize the values of the parameters (e.g., μ,ζ,θ) of the probability density functions, where small perturbations to these parameters are introduced. Previously computed parameter values p₀=(μ₀,ζ₀,θ₀) for each of the probability density functions are used as the respective candidate guesses for suggested local minima.

A quantitative assessment as to the model error is calculated (via processor 108) by taking the difference between the observed data (i.e., the electrical signal) and the modeling function, specifically:

Δ=x(t)−s(t) (7)

Alternatively, the model error may be defined as a time-dependent model error function Δ(t)=x(t)−s(t). A (global) model error threshold parameter is defined, ε, for if Δ>ε it is said that the modeling function inadequately fits the observed data. Generally, the model error threshold parameter may be a time-dependent function ε(t), such that for every time value that satisfies the inequality Δ(t)>ε(t), it is said that the modeling function inadequately fits the observed data at that time value. In this case, it is hypothesized that the model error Δ is due to unresolved components (e.g., chromatographic peaks, noise) such as in the situation of unresolved overlapping peaks (e.g., peak 210). To further explicate the relationship between the exhibited model error and unresolved chromatographic peaks, reference is now further made to FIG. 2C. Specifically, FIG. 2C is a schematic illustration of a graph of the calculated time-dependent model error resulting from the initially estimated modeling function of FIG. 2B, plotted in conjunction with a graph of a time-dependent model error threshold function. FIG. 2C illustrates that the greatest model error occurs between t₂ and t₄, specifically at t₃, which corresponds to the temporal neighborhood of peak 210. Given, that the model error in that neighborhood exceeds the values for the time-dependent model error threshold parameter, it is therefore suspected that peak 210 is composite. This model error may be caused, therefore, by unresolved or concealed chromatographic peaks, which were unidentified and unaccounted for in the initially estimated modeling function. Analysis of the temporal neighborhood of peak 210 indicates that the model error is substantially negligible at t₁ and t₆, and that the maximum value of the modeling function for peak 210 occurs at t₄. To estimate the number of peaks concealed within a suspected composite peak, processor 106 may analyze the curvature of the time-dependent model error (function), such as for example, information contained in the second derivative thereof (e.g., points of inflection). Peak 210, which was in effect modeled as a single peak (e.g., by a probability density function Oₗ(t)) in the initially estimated modeling function is now suspected as being composite (i.e., containing a plurality of peaks) and remodeled using a plurality q of probability density functions

$$( e . g . , {\sum }_{q} {O}_{q} ( t ) ) ,$$

by taking into account the residuum model error. A refined time-dependent modeling function x₂(t) is defined by incorporating a remodeled expression for peak 210 (i.e., or generally other peaks for that matter) suspected of being composite:

$${x}_{2} ( t ) = {\sum }_{j} {β}_{j} {D}_{j} ( t ) + {\sum }_{k} {η}_{k} {H}_{k} ( t ) + [ {\sum }_{l , l \neq \tilde{l}} {δ}_{l} {O}_{l} ( t ) + {\sum }_{q} {δ}_{q} {O}_{q} ( t ) ] + {\sum }_{m} {ι}_{m} {I}_{m} ( t ) \qquad ( 8 )$$

Now the refined time-dependent modeling function is taken as the current modeling function, and the modeling process is repeated by taking successively refined modeling functions x₃, x₄, x₅. . . until the model error in equation (7) is minimized. A test for the hypothesis that peak 210 is composite may be substantially supported by the indication of whether the model error is gradually reduced and converges to a minimum, by using successively refined time-dependent modeling functions in each iteration in the modeling process. If in fact the modeling error is reduced to a minimum by employing a specific number (e.g., two) of probability density functions to model peak 210, it serves to an extent, an indication that peak 210 is composite, and that it is composed from that specific number overlapping peaks. Each of the peaks from which peak 210 is identified to be composed from is modeled by a respective probability density function. For illustrative purposes, reference is now further made to FIG. 2D, which is a schematic illustration of a refined estimate of the time-dependent modeling function of FIG. 2B, modeled according to the chromatogram of FIG. 2A. In the example given, peak 210 (FIG. 2B) is resolved into two distinct peaks 216 and 218 (FIG. 2D), their maxima occurring respectively at t₂ and t₅ (FIGS. 2B and 2C), which were unidentified at the onset of the modeling process. At this point, if these resolved peaks substantially match reference peaks when compared to the database (i.e., in either of sets D′ and H′), in subsequent modeling functions, these peaks will be reclassified and remodeled according to their respectively determined classification. A statistical distance measure (i.e., statistical divergence) such as the Kullback-Leibler divergence (i.e., information divergence) for gamma probability distribution functions may be employed as a test for determining a measure of match or alternatively, a measure of difference between reference peaks stored in the database and newly identified resolved peaks, suspected to correspond to the respective reference peaks, given by the following equation (9):

$${D}_{KL} ( {ρ}_{R} , {σ}_{R} ∥ ρ , σ ) = log ( \frac{Γ ( ρ ) {σ}_{R}^{{ρ}_{R}}}{Γ ( {ρ}_{R} ) {σ}^{R}} ) + ( {ρ}_{R} - ρ ) [ ψ ( {ρ}_{R} ) - log {σ}_{R} ] + {ρ}_{R} \frac{σ - {σ}_{R}}{{σ}_{R}} \qquad ( 9 )$$

where Γ(ρ_{R},σ_{R}) is the gamma probability density function associated with reference (R) chromatographic data (i.e., of a particular reference chromatographic peak, stored in the database), Γ(ρ, σ) is the gamma probability density function, which is to be tested (e.g., corresponding to a newly resolved chromatographic peak), and ψ(ρ_{R}) is the digamma function. The parameter ρ equals the shape parameter ζ, and σ is the rate parameter (i.e., defined as the inverse scale parameter: σ=1/θ), where the subscript “R” denotes parameters of reference data. A minimal value returned by the Kullback-Leibler divergence indicates the best attained match for a particular pair of probability distribution functions, namely, a reference stored in the database and one which is tested in suspicion of substantially matching the reference. Alternatively, the Kullback-Leibler divergence may be utilized to test the measure of difference between other pairs of reference and observed chromatographic peaks. Thus, the Kullback-Leibler divergence may be employed to test the measure of difference between a multi-marker (a plurality of markers) in the database and a plurality of respective peaks of a given sample (e.g., such as in a multi-comparison test). Generally, given a library (i.e., a database) of multi-markers, the markers with the maximal information divergence are the most probable of being detected. Further alternatively, other statistical distance measures for evaluating the intersection between distributions (i.e., of peaks) can be employed instead of the Kullback-Leibler divergence criterion.

Once the model error is minimized, the modeling process terminates, and the refined modeling function is substantially determined, with a substantially reasonable level of repeatability. Each of the determined coefficients βⱼ, ηₖ,δₗ and tₘ in the refined modeling function represents a weighted term for its respective probability density function, which in turn models a respective chromatographic peak. In other words, each coefficient represents the relative value of the detected concentration for a particular chemical in the sample. Typically, to account for the presence of disproportionate concentrations of components in a given sample, the coefficients in equation (8) are normalized by evaluating a measure of statistical dispersion, such as the interquartile range (IQR). The IQR, defined as the difference between the third and first quartiles (Q3−Q1), is calculated and used to normalize each of the detected peaks (i.e., the maximum value of each peak (corresponding to its respective detected maximum concentration) is divided by the IQR).

Nevertheless, certain chemical compounds whose detected concentrations may be below a predefined value such that they may be insignificant, statistically. For example, low detected concentrations of a particular chemical, which defines a certain biomarker, may be an indication to the absence of a particular disease to which this biomarker is attributed to. Therefore, for each of the coefficients in equation (8) there is defined a respective threshold parameter (not shown) that sets a minimum value, for if it is exceeded, the probability density function corresponding to that coefficient is considered as significant. Consequently, if one of the resolved peaks, for example, corresponds to a chemical compound required for the identification of a particular biomarker that was previously undetected due to overlapping peak phenomenon, it may now be detected. It is noted that system 100 can generate an indication (not shown) in the case where a particular sample cannot be analyzed (e.g., a failure to model).

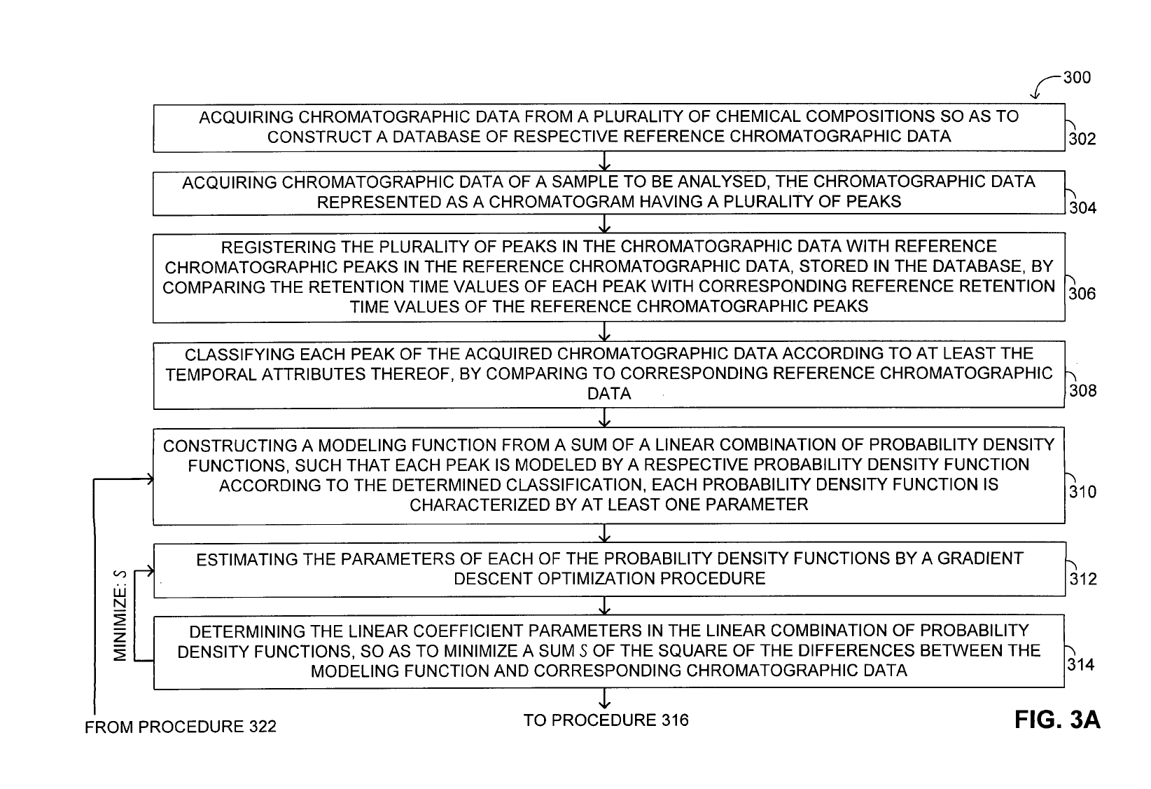

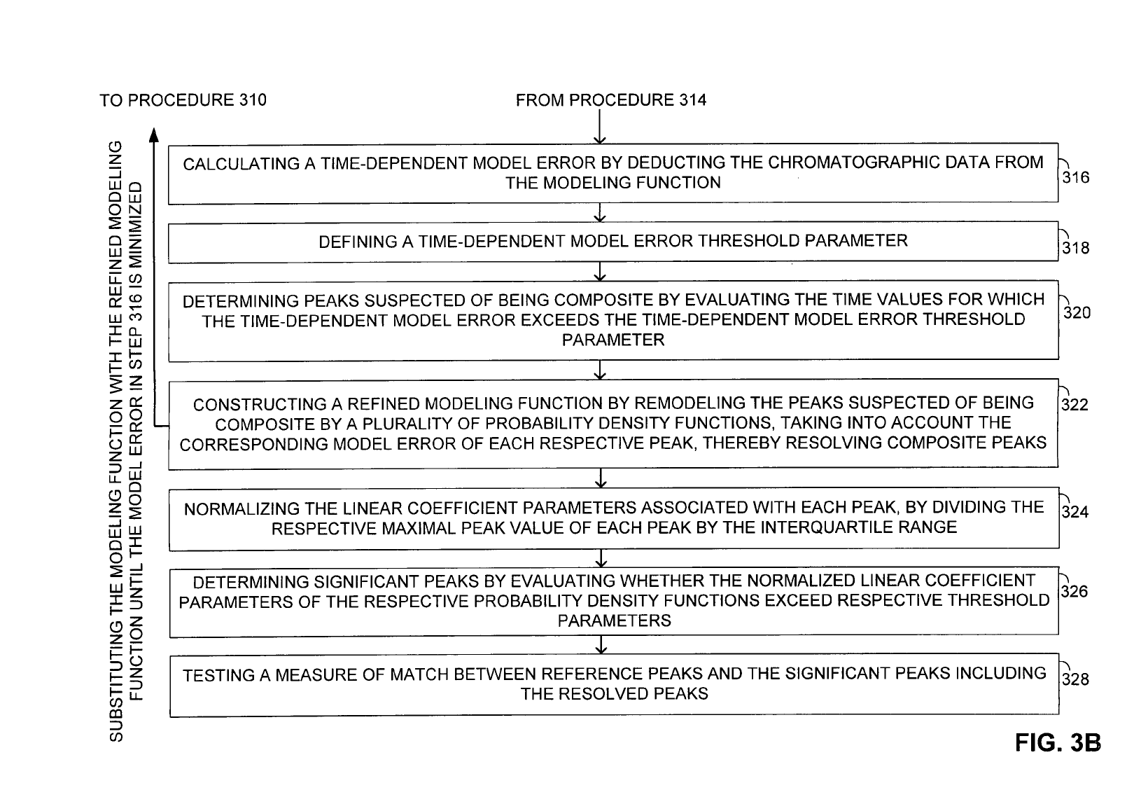

Reference is now made to FIGS. 3A and 3B. FIG. 3A is a schematic block diagram illustrating the method for resolving and identifying components within overlapping chromatographic peaks whose different constituents compose a given sample, generally referenced 300, constructed and operative according to another embodiment of the disclosed technique. FIG. 3B is a schematic block diagram illustrating a continuation of the method from FIG. 3A. In procedure 302, chromatographic data from a plurality of chemical compositions are acquired, so as to construct a database of respective reference chromatographic data. With reference to FIG. 1, system 100 acquires, via detector 106 chromatographic data from a plurality of chemical compositions (not shown) so as to construct a database of respective reference chromatographic data to be stored in memory 110.

In procedure 304, chromatographic data of a sample to be analyzed is acquired, where the chromatographic data is represented as a chromatogram having a plurality of peaks. With reference to FIGS. 1 and 2A, system 100 (FIG. 1) acquires via detector 106 chromatographic data of a sample to be analyzed. The acquired chromatographic data of the sample is represented as chromatogram 200 (FIG. 2A) having a plurality of chromatographic peaks 202, 204, 206, 208, 210, 212 and 214.

In procedure 306, the plurality of peaks in the chromatographic data are registered with reference chromatographic peaks in the reference chromatographic data, stored in the database, by comparing the retention time values of each chromatographic peak with corresponding reference retention time values of the reference chromatographic peaks.

In procedure 308, each peak of the acquired chromatographic data is classified according to at least the temporal attributes thereof, by comparing to corresponding reference chromatographic data.

In procedure 310, a modeling function form a sum of a linear combination of probability density functions is constructed, such that each peak is modeled by a respective probability density function according to the determined classification, where each probability density function is characterized by at least one parameter. With reference to equation (2), the modeling function x(t) is modeled with the plurality of probability density functions Dⱼ(t), Hₖ(t), Oₗ(t), and Iₘ(t).

In procedure 312, the parameters of each of the probability density functions are estimated by a gradient descent optimization procedure. With reference to equation (5), the column vector p of a preset number of real-valued parameters p=(μ,ζ,θ) of each of the probability density functions are estimated. p In procedure 314, the linear coefficient parameters in the linear combination of probability density functions are determined, so as to minimize a sum s of the square of the differences between the modeling function and corresponding chromatographic data. With reference to equation (6), the linear coefficient parametersβⱼ,ηₖ,δₗ and tₘ are determined, so as to minimize the sum s defined in equation (6). The parameters of each of the probability density functions are estimated again in procedure 312 by the gradient descent optimization method. Procedures 312 and 314 are looped (i.e., may be iterated over several times) until the sum s is minimized.

In procedure 316, a time-dependent model error is calculated by deducting the chromatographic data from the modeling function. With reference to FIG. 2C and equation (7), the model error is calculated by taking the difference between the observed data (i.e., the electrical signal) and the modeling function.

In procedure 318, a time-dependent model error threshold parameter is defined. This parameter may be defined as a time-dependent function. With reference to FIG. 2C, the time-dependent model error threshold parameter, ε is plotted.

In procedure 320, peaks suspected of being composite are determined by evaluating the time values for which the time-dependent model error exceeds the time-dependent model error threshold parameter. With reference to FIGS. 2A and 2C, the time-dependent model error temporally corresponding to peak 210, substantially exceeds the model error threshold parameter between the time values of t₂ and t₅.

In procedure 322, a refined modeling function is constructed by remodeling the peaks suspected of being composite by a plurality of probability density functions, taking into account the corresponding model error of each respective peak, thereby resolving composite peaks. Successively refined modeling functions are substituted iteratively with the modeling function in procedure 310 until the model error in procedure 316 is minimized. With reference to FIG. 2A and equation (8), peak 210 is suspected as being composite and is remodeled by a plurality of probability density functions so as to define a refined time-dependent modeling function, which is taken as the current modeling function in equation (2), and the modeling process is repeated iteratively (i.e., from step 310) by taking successively refined modeling functions, until the model error in equation (7) is minimized.

In procedure 324 the linear coefficient parameters associated with the peak is normalized, by dividing the respective maximal peak value of each peak by the IQR. With reference to equation (8), the linear coefficient parameters βⱼ,ηₖ,δₗ and tₘ are normalized, by the calculated IQR.

In procedure 326, significant peaks are determined by evaluating whether the normalized linear coefficient parameters of the respective probability density functions exceed respective threshold parameters. With reference to equation (8), the significant peaks (not shown) are determined by evaluating whether the linear coefficient parametersβⱼ,η_{k,δ}ₗ and tₘ exceed respective threshold parameters (not shown).

In procedure 328 a measure of match between reference peaks and the plurality of peaks including the resolved peaks are tested. With reference to FIGS. 1 and 2D as well as equation (9), resolved peaks 216 and 218 are tested with the Kullback-Leibler divergence to test a measure of match (or measure of difference) between them and chromatographic reference peaks stored in the database of memory 110 (FIG. 1).

It will be appreciated by persons skilled in the art that the disclosed technique is not limited to what has been particularly shown and described hereinabove. Rather the scope of the disclosed technique is defined only by the claims, which follow.

1. A self-reliant method employing gas chromatography for determining a measure of match between gas chromatographic data respective of a sample and reference data, the gas chromatographic data includes at least one chromatographic peak, the reference data includes at least one reference chromatographic peak, the method comprising the procedures of:
acquiring said gas chromatographic data;
registering said at least one chromatographic peak with said at least one reference chromatographic peak;
classifying said at least one chromatographic peak with according to at least one temporal attribute thereof with respect to said reference data, according to said procedure of registering;
determining a plurality of parameters in a modeling function, so as to substantially fit said modeling function to said gas chromatographic data, said modeling function defined as a sum of a linear combination of probability distribution functions; and
estimating said measure of match according to a degree of fitness between said modeling function and said gas chromatographic data.

2. The method according to claim 1, wherein said procedure of acquiring is performed by one-dimensional gas chromatographic separation techniques.

3.-4. (canceled)

5. The method according to claim 1, further comprising a procedure of normalizing a signal, acquired in said procedure of acquiring so as to account for presence of disproportionate concentrations of constituents substantially composing said sample.

6. The method according to claim 1, further comprising a procedure of storing at least one of said gas chromatographic data and said reference data in a memory device so as to form a database, said at least one reference chromatographic peak substantially corresponds to at least one known chemical composition.

7. (canceled)

8. The method according to claim 1, further comprising a procedure of calibrating said reference data with mass spectrometry data corresponding to said at least one known chemical composition.

9. The method according to claim 1, wherein particular ones of said at least one known chemical composition define at least one biomarker that is substantially representative with at least one biological state of a biological being from which said sample is acquired.

10. The method according to claim 1, wherein said procedure of registering involves comparing a retention time value of said at least one chromatographic peak with a respective reference retention time value of said at least one chromatographic reference peak.

11. (canceled)

12. The method according to claim 10, wherein said procedure of registering is performed by employing a transformation function ƒ(t), chosen such that s(f(t) maximally matches with corresponding reference data r(t), where s represents a signal acquired in said procedure of acquiring.

13. (canceled)

14. The method according to claim 12, wherein said procedure of registration further involves adding to said sample at least one reference chemical having at least one known retention time, so as to produce respective at least one known chromatographic peak, whereby said transformation function is chosen according to said at least one known chromatographic peak.

15. (canceled)

16. The method according to claim 12, further comprising a procedure of constructing said modeling function, such that said at least one chromatographic peak is modeled by respective said probability distribution functions, according to said procedure of classifying.

17. (canceled)

18. The method according to claim 16, wherein said modeling function includes at least one term in the sum having a form:
$$x ( t ) = {\sum }_{j} {β}_{j} {D}_{j} ( t ) + {\sum }_{k} {η}_{k} {H}_{k} ( t ) + {\sum }_{l} {δ}_{l} {O}_{l} ( t ) + {\sum }_{m} {ι}_{m} {I}_{m} ( t )$$
where x(t) represents said modeling function that is time dependent, where each of said probability distribution functions Vᵢ is represented by one of said probability distribution functions Dⱼ(t), Hₖ(t), Oₗ(t) and Iₘ(t), where βⱼ, ηₖ, δₗ and tₘ are respective coefficients in the linear combinations with each of said probability distribution functions, where j, k, l, and m are positive integers, each of said probability distribution functions is characterized by at least one of said plurality of parameters,
wherein said Dⱼ(t) model said at least one chromatographic peak to said at least one chromatographic reference peak respective of said at least one biomarker, said at least one chromatographic peak being at least partially composite in said gas chromatographic data, said at least one biomarker substantially representative of an adverse said biological state, wherein said Hₖ(t) model said at least one chromatographic peak, being at least partially composite in said gas chromatographic data, to said at least one chromatographic reference peak that is either one of being respective of said at least one biomarker, and unknown to be representative of said adverse biological state, wherein said Iₘ(t) model said at least one chromatographic peak that is substantially resolved, and wherein said Oₗ(t) model either one of said at least one chromatographic peak that substantially does not fit to said plurality of reference data, and remainder terms yielded from modeling of said modeling function to said gas chromatographic data.

19. The method according to claim 18, wherein said probability distribution functions are selected from a list consisting of:
exponentially modified Gaussian (EMG) function;
gamma probability distribution function;
polynomial modified Gaussian function;
skew-normal distribution function;
Chi distribution function;
Maxwell-Bolzmann distribution function of normalized molecular speeds;
Maxwell-Boltzmann distribution function modified for retention times;
Poisson distribution; and
Rayleigh distribution function.

20. The method according to claim 16, further comprising a procedure of determining which of said at least one chromatographic peak is to be modeled by which of said probability distribution functions.

21.-23. (canceled)

24. The method according to claim 20, wherein said procedure of determining said plurality of parameters includes a procedure of iteratively evaluating candidate solutions for said plurality of parameters so that a sum of the square of the differences between said modeling function and said signal is minimized.

25. (canceled)

26. The method according to claim 24, further comprising a procedure of determining which of said at least one chromatographic peak is composite by evaluating time values for which a time-dependent model error exceeds a time-dependent model threshold parameter, said time-dependent model error is calculated by taking the difference between said signal and said modeling function.

27. The method according to claim 26, further comprising a procedures of:
redetermining which said at least one chromatographic peak that is said composite, is to be remodeled by which at least two of said probability distribution functions
remodeling said composite said at least one chromatographic peak, determined according to said procedure of re-determining, such to substantially resolve it into at least one substantially resolved chromatographic peak; and
refining iteratively said modeling function to account for said at least one substantially resolved chromatographic peak so that said time-dependent model error is minimized.

28.-30. (canceled)

31. The method according to claim 27, wherein coefficients of said probability distribution functions that model respective said at least one chromatographic peak are normalized by dividing the maximal value of each respective said at least one chromatographic peak by the interquartile range (IQR).

32. The method according to claim 31, further comprising a procedure of determining significant peaks, by defining a threshold parameter for each of said coefficients, and evaluating which of normalized said coefficients that are respective of said probability distribution functions that model respective said at least one chromatographic peak, exceed respective said threshold parameter.

33. The method according to claim 32, wherein said estimating said measure of match is according to a statistical distance measure between said at least one chromatographic reference peak and either one of respective said at least one substantially resolved chromatographic peak and respective one of said significant peaks.

34.-36. (canceled)

37. A self-reliant gas chromatography system for analysis of gas chromatographic data comprising:
a chromatographic separation column for separating a sample into a plurality of constituents, said chromatographic separation column includes an inlet and an outlet;
a sample delivery device coupled with said chromatographic separation column at said inlet, for providing said sample to said chromatographic separation column;
a detector in communication with said outlet of said chromatographic separation column for detecting at least a portion of said plurality of constituents, said detector producing a signal that includes said gas chromatographic data respective of characteristics of the detected said at least a portion of said sample, said gas chromatographic data including at least one chromatographic peak;
a memory device for storing said gas chromatographic data and a plurality of reference data, said reference data including at least one reference chromatographic peak; and
a processor coupled with said detector and with said memory device, said processor registers said at least one chromatographic peak with said at least one reference chromatographic peak, said processor classifies said at least one chromatographic peak according to at least one temporal attribute thereof with respect to said reference data, according to registration between said at least one chromatographic peak with said at least one reference chromatographic peak, said processor determines a plurality of parameters in a modeling function so as to substantially fit said modeling function to said gas chromatographic data, said modeling function defined as a sum of a linear combination of probability distribution functions, said processor estimates a measure of match between said gas chromatographic data and said plurality of reference data according to a degree of fitness between said modeling function and said gas chromatographic data.

38.-44. (canceled)

45. The system according to claim 37, wherein said processor normalizes said signal so as to account for presence of disproportionate concentrations of said plurality of constituents substantially composing said sample.

46. (canceled)

47. The system according to claim 37, wherein said plurality of reference data forms a database, said at least one reference chromatographic reference peak that substantially corresponds to at least one known chemical composition.

48. The system according to claim 47, wherein said plurality of reference data is calibrated with mass spectroscopy data corresponding to said at least one known chemical composition.

49. The system according to claim 47, wherein particular ones of said at least one known chemical composition define at least one biomarker that is substantially representative with at least one biological state of a biological being from which said sample is acquired.

50. (canceled)

51. The system according to claim 37, wherein said processor registers said at least one chromatographic peak with said at least one chromatographic reference peak, by comparing a retention time value of said at least one chromatographic peak with a respective reference retention time value of said at least one chromatographic reference peak.

52. (canceled)

53. The system according to claim 51, wherein said processor said registers by employing a transformation function ƒ(t), chosen such that s(f(t)) maximally matches with corresponding said plurality of reference data r(t), where s represents said signal.

54. (canceled)

55. The system according to claim 53, wherein said processor said registers at least one reference chemical added to said sample and having at least one known retention time, so as to produce respective at least one known chromatographic peak, whereby said transformation function is chosen according to said at least one known chromatographic peak.

56. (canceled)

57. The system according to claim 51, wherein said processor constructs said modeling function, such that said at least one chromatographic peak is modeled by respective said probability distribution functions, according to said classification by said processor.

58. (canceled)

59. The system according to claim 57, wherein said modeling function includes at least one term in the sum having a form:
$$x ( t ) = {\sum }_{j} {β}_{j} {D}_{j} ( t ) + {\sum }_{k} {η}_{k} {H}_{k} ( t ) + {\sum }_{l} {δ}_{l} {O}_{l} ( t ) + {\sum }_{m} {ι}_{m} {I}_{m} ( t )$$
where x(t) represents said modeling function that is time dependent, where each of said probability distribution functions Vᵢ is represented by one of said probability distribution functions Dⱼ(t), Hₖ(t), Oₗ(t) and Iₘ(t), where βⱼ, ηₖ, δₗ and tₘ are respective coefficients in the linear combinations with each of said probability distribution functions, where j, k, l, and m are positive integers, each of said probability distribution functions is characterized by at least one of said plurality of parameters,
wherein said Dⱼ(t) model said at least one chromatographic peak to said at least one chromatographic reference peak respective of said at least one biomarker, said at least one chromatographic peak being at least partially composite in said gas chromatographic data, said at least one biomarker substantially representative of an adverse said biological state, wherein said Hₖ(t) model said at least one chromatographic peak, being at least partially composite in said gas chromatographic data, to said at least one chromatographic reference peak that is either one of being respective of said at least one biomarker, and unknown to be representative of said adverse biological state, wherein said Iₘ(t) model said at least one chromatographic peak that is substantially resolved, and wherein said Oₗ(t) model either one of said at least one chromatographic peak that substantially does not fit to said plurality of reference data, and remainder terms yielded from modeling of said modeling function to said gas chromatographic data.

60. The system according to claim 59, wherein said probability distribution functions are selected from a list consisting of:
exponentially modified Gaussian (EMG) function;
gamma probability distribution function;
polynomial modified Gaussian function;
skew-normal distribution function;
Chi distribution function;
Maxwell-Boltzmann distribution function of normalized molecular speeds;
Maxwell-Boltzmann distribution function modified for retention times;
Poisson distribution; and
Rayleigh distribution function.

61. (canceled)

62. The system according to claim 59, wherein said processor determines which of said at least one chromatographic peak is to be modeled by which of said probability distribution functions.

63.-66. (canceled)

67. The system according to claim 62, wherein said processor determines said plurality of parameters by iteratively evaluating candidate solutions for said plurality of parameters so that a sum of the square of the differences between said modeling function and said signal is minimized.

68. (canceled)

69. The system according to claim 67, wherein a time-dependent model error threshold parameter is defined, wherein said processor determines which of said at least one chromatographic peak is composite by evaluating time values for which said time-dependent model error exceeds said time-dependent model error threshold parameter, said processor calculates said time-dependent model error by taking the difference between said signal and said modeling function.

70. The system according to claim 69, wherein said processor re-determines which said at least one chromatographic peak that is said composite, is to be remodeled by which at least two of said probability distribution functions.

71. The system according to claim 70, wherein said processor iteratively refines said modeling function such that said at least one chromatographic peak that is said composite and previously modeled by a respective said probability distribution function is said remodeled by said at least two of said probability distribution functions, such to substantially resolve said at least one chromatographic peak that is said composite into at least one substantially resolved chromatographic peak.

72.-73. (canceled)

74. The system according to claim 71, wherein said coefficients of said probability distribution functions that model respective said at least one chromatographic peak are normalized by said processor, by dividing the maximal value of each respective said at least one chromatographic peak by the interquartile range (IQR).

75. The system according to claim 74, wherein at least one threshold parameter is defined for each of said coefficients, wherein said processor determines a significant chromatographic peak by evaluating which of normalized said coefficients that are respective of said probability distribution functions that model respective said at least one chromatographic peak, exceed respective said at least one threshold parameter.

76. The system according to claim 75, wherein said processor said estimates said measure of match according to a statistical distance measure between said at least one chromatographic reference peak and either one of respective said at least one substantially resolved chromatographic peak and respective said significant chromatographic peak.

77.-80. (canceled)

81. The method according to claim 9, wherein said at least one biological state is an adverse medical condition that includes cancer.

82. The system according to claim 49, wherein said at least one biological state is an adverse medical condition that includes cancer.
